(19) United States
(12) Patent Application Publication
(10) Pub. No.: US 2024/0419182 A1
(43) Pub. Date: Dec. 19, 2024

(54) METHOD AND COMPUTING DEVICE FOR GLOBAL LOCALIZATION OF MOBILE ROBOTS

(71) Applicant: ELECTRONICS AND TELECOMMUNICATIONS RESEARCH INSTITUTE, Daejeon (KR)

(72) Inventor: Su Yong AN, Daejeon (KR)

(73) Assignee: ELECTRONICS AND TELECOMMUNICATIONS RESEARCH INSTITUTE, Daejeon (KR)

(21) Appl. No.: 18/702,481

(22) PCT Filed: Sep. 2, 2022
(86) PCT No.: PCT/KR2022/013195

§ 371 Date: Apr. 18, 2024

(30) Foreign Application Priority Data
Oct. 21, 2021 (KR) 10-2021-0141243
Aug. 23, 2022 (KR) 10-2022-0105413

(51) Int. Cl. G05D 1/246; G05D 1/648; G05D 111/10

(52) U.S. Cl. CPC G05D 1/2462; G05D 1/6482; G05D 2111/10

(57) ABSTRACT

A method for global localization of a mobile robot is disclosed. The method compares a histogram value, obtained by quantifying geometric and structural features of each query submap image divided from a global map image, with geometric and structural features of submap images stored in a database to select a submap image which is the most similar to a query submap image, and performs the global localization of the mobile robot, based on coordinate information included in the selected submap image.

### DESCRIPTION

### Technical Field

The present invention relates to global localization technology of mobile robots.

### Background Art

Mobile robots are robots which autonomously move in a space and have capability to process high-level tasks such as guidance, delivery, surveillance, and cleaning.

Reliable self-positioning technology is essential for high-level tasks of mobile robots, and in robotics field, this is referred to as ‘localization’.

Localization may be greatly categorized into local localization and global localization, and the global localization is technology for finding a current position of a robot without previous knowledge of an initial position, unlike the local localization.

The global localization includes various methods based on the kind of sensor used in building a map, and a method of using two-dimensional (2D) occupancy grid map among the various methods is used as global localization for indoor driving robots.

The method is a method which converts accumulated 2D laser scan data, obtained by a laser scanner equipped in a robot, into a 2D occupancy grid map and extracts a feature point from a corresponding image. In feature point extraction, a scale invariant feature transform (SIFT) algorithm and a speeded up robust feature (SURF) algorithm may be widely used in object recognition field.

Such an access method has an advantage where many algorithms proposed may be reused in computer visions, but a mismatch between a 2D occupancy grid map and a real space may occur due to sensor noise or a map building error in a process of generating the 2D occupancy grid map.

### DISCLOSURE

### Technical Problem

The present invention is devised to solve the above-described problem and is for providing a method and apparatus for global localization of mobile robots, which use geometric feature information and structural feature information extracted from a 2D occupancy grip map so as to increase efficiency of global localization of mobile robots.

### Technical Solution

A method for global localization of a mobile robot according to an aspect of the present invention for accomplishing the above-described object may be a method for global localization of a mobile robot, performed by a processor of a computing device equipped in the mobile robot, the method including: dividing a global map image into a plurality of query submap images; calculating a histogram value representing a geometric feature of each query submap image; calculating a reflection symmetry score representing structural feature information about each query submap image; calculating a submap similarity score between each query submap image and submap images stored in a database, based on the histogram value and the reflection symmetry score; and determining a submap image which is the most similar to the query submap image, based on the submap similarity score, and performing the global localization of the mobile robot, based on coordinate information included in the determined submap image.

In an embodiment, the dividing of the global map image into the plurality of query submap images may include: generating the global map image by using a sensor equipped in the mobile robot; extracting a junction point, defining a point from which a movement path of the mobile robot branches, from the global map image; and dividing the global map image into the plurality of query submap images having a certain radius with respect to the junction point.

In an embodiment, the extracting of the junction point may include: transforming the global map image into an edge map image, based on an image processing technique; and when an n×n image patch including a center pixel of the edge map image and peripheral pixels surrounding the center pixel is assumed, extracting the center pixel as the junction point when a pixel value of the center pixel differs from pixel values of at least three peripheral pixels.

In an embodiment, the calculating of the histogram value representing the geometric feature of each query submap image may include: calculating a boundary histogram value representing a geometric feature of a boundary region, where the mobile robot is incapable of moving, in each query submap image; and calculating a free space histogram value representing a geometric feature of a free space region, where the mobile robot is capable of moving, in each query submap image.

In an embodiment, the calculating of the boundary histogram value may include: transforming each query submap image into an edge map image, based on an image processing technique; sampling boundary points configuring the boundary region in the edge map image; pairing the sampled boundary points to generate a plurality of boundary point pairs; and calculating the boundary histogram value, based on a distance value between two boundary points included in each boundary point pair.

In an embodiment, the calculating of the free space histogram value may include: transforming each query submap image into an edge map image, based on an image processing technique; extracting free space points configuring the free space region in the edge map image; pairing two free space points having a shortest path distance value among the extracted free space points to generate a plurality of free space point pairs; and calculating the free space histogram value, based on the shortest path distance value of each free space point pair.

In an embodiment, the calculating of the reflection symmetry score may include: transforming each query submap image into an edge map image, based on an image processing technique; detecting axes of reflection symmetry in the edge map image, based on angles of line segments having a certain length; transforming the edge map image into a blurred image, based on an image blurred technique; and calculating, as the reflection symmetry score, a similarity score between the blurred image and a flipped blurred image flipped with respect to the detected axes of reflection symmetry.

In an embodiment, the method may further include rotating the edge map image so that the detected axes of reflection symmetry are vertically aligned, between the detecting of the axis of reflection symmetry and the transforming of the edge map image into the blurred image.

In an embodiment, the calculating of the submap similarity score may include: calculating a first difference value between the histogram value of each query submap image and histogram values representing the geometric features of the submap images stored in the database; calculating a second difference value between the reflection symmetry score of each query submap image and reflection symmetry scores representing structural features of the submap images stored in the database; and calculating the submap similarity score, based on the first and second difference values.

In an embodiment, the calculating of the first difference value may include: calculating a difference value between a boundary histogram value, representing the geometric feature of a boundary region where the mobile robot is incapable of moving in each query submap image, and boundary histogram values representing the geometric feature of a boundary region where the mobile robot is incapable of moving in the submap images; and calculating a difference value between a free space histogram value, representing the geometric feature of a free space region where the mobile robot is capable of moving in each query submap image, and free space histogram values representing the geometric feature of a free space region where the mobile robot is capable of moving.

A computing device for global localization of a mobile robot according to another aspect of the present invention may include: an image divider configured to divide an occupancy grid map image into a plurality of query submap images; a feature extractor configured to calculate a histogram value representing a geometric feature of each query submap image and calculate a reflection symmetry score representing a symmetry feature of each query submap image; a submap similarity score calculator configured to calculate a submap similarity score between each query submap image and submap images stored in a database, based on the histogram value and the reflection symmetry score; and a global localization processor configured to determine a submap image which is the most similar to the query submap image, based on the submap similarity score, and perform the global localization of the mobile robot, based on coordinate information included in the determined submap image.

In an embodiment, the image divider may divide the occupancy grid map image into a plurality of query submap images with respect to a junction point from which a movement path of the mobile robot branches, in the occupancy grid map image.

In an embodiment, the feature extractor may include: a first geometric feature extractor configured to calculate a boundary histogram value obtained by quantifying distribution features of a boundary region where the mobile robot is incapable of moving, in each query submap image; a second geometric feature extractor configured to calculate a free space histogram value obtained by quantifying distribution features of a free space region where the mobile robot is capable of moving, in each query submap image; and a structural feature extractor configured to calculate a reflection symmetry score obtained by quantifying symmetricity of each query submap image.

In an embodiment, the submap similarity score calculator may include: a first subtractor configured to calculate a difference value between a boundary histogram value obtained by quantifying geometric features of a boundary region in each query submap image and a boundary histogram value obtained by quantifying geometric features of a boundary region in a submap image stored in the database; a second subtractor configured to calculate a difference value between a free space histogram value obtained by quantifying geometric features of a free space region in each query submap image and a boundary histogram value obtained by quantifying geometric features of a free space region of the submap image stored in the database; and a third subtractor configured to calculate a difference value between the reflection symmetry score obtained by quantifying symmetricity of each query submap image and a reflection symmetry score obtained by quantifying symmetricity of the submap image stored in the database.

In an embodiment, the submap similarity score calculator may perform an arithmetic operation on the difference values calculated by the first to third subtractors to calculate a similarity score between each query submap image and the submap images.

In an embodiment, the submap similarity score calculator may further include an adder configured to summate the difference value calculated by the first subtractor and the difference value calculated by the second subtractor, and the submap similarity score calculator may perform an arithmetic operation on the difference value calculated by the third subtractor as a weight and a value summated by the adder to calculate a similarity score between each query submap image and the submap images.

A method for global localization performed by a processor of a computing device equipped in a mobile robot, according to another aspect of the present invention, may include: calculating a boundary histogram value obtained by quantifying distribution features of a boundary region where the mobile robot is incapable of moving, in each query submap image divided from a global map image; calculating a free space histogram value obtained by quantifying distribution features of a free space region where the mobile robot is capable of moving, in each query submap image; calculating a reflection symmetry score obtained by quantifying symmetricity of each query submap image with respect to an axis of symmetry extracted from each query submap image; comparing the boundary histogram value, the free space histogram value, and the reflection symmetry score of each query submap image with a boundary histogram value, a free space histogram value, and a reflection symmetry score of submap images input from a database to select a submap image, which is the most similar to each query submap image, from among submap images stored in the database; and performing the global localization of the mobile robot, based on coordinate information included in the selected submap image.

In an embodiment, the global map image may be a 2D or 3D occupancy grid map image.

### Advantageous Effect

The present invention proposes global localization of mobile robots based on geometric feature information and structure feature information (symmetricity) extracted from a submap.

Therefore, the present invention may introduce structural information about a submap (i.e., a symmetry score) and may digitize (quantify) structural feature information about an indoor space, thereby enhancing the matching performance of the submap.

Moreover, the present invention may provide explicit integration of geometric feature information and structural feature information about a submap to secure robustness to noise applied to the submap.

Moreover, the present invention may be applied to all sensors (for example, ultrasonic sensors, 2D/3D LiDAR, 3D depth cameras) for generating a two-dimensional (2D) occupancy grid map.

Moreover, the present invention may be applied to a 2D floor plan map of an indoor building, and thus, it may not be required to previously build a map by using a robot.

### DESCRIPTION OF DRAWINGS

FIG. 1 is a flowchart for describing a method for global localization of mobile robots according to an embodiment of the present invention.

FIG. 2 is a diagram illustrating an example of a two-dimensional (2D) occupancy grid map used as a global map according to an embodiment of the present invention.

FIG. 3 is a flowchart for describing in detail a process of partitioning a 2D occupancy grid map, used as a global map, a plurality of submaps according to an embodiment of the present invention.

FIG. 4 is a diagram illustrating an edge map image which is generated in step S120 of FIG. 3.

FIG. 5 is a diagram illustrating candidate junction points extracted in step S130 of FIG. 3 and junction points extracted in step S140 on the edge map image illustrated in FIG. 4.

FIG. 6 is an exemplary diagram of a plurality of submaps partitioned from the 2D occupancy grid map in step S150 of FIG. 3.

FIG. 7 is a flowchart for describing in detail a statistic calculation process on geometric feature information about a boundary region according to an embodiment of the present invention.

FIG. 8 is an exemplary diagram of four submaps where a boundary region is displayed as boundary points, according to an embodiment of the present invention.

FIG. 9 is a graph showing a boundary histogram of the four submaps illustrated in FIG. 8.

FIG. 10 is a flowchart for describing in detail a statistic calculation process on geometric feature information about a free space region according to an embodiment of the present invention.

FIG. 11 is an exemplary diagram of four submaps where a free space region is displayed as free space points, according to an embodiment of the present invention.

FIG. 12 is a graph showing a free space histogram of the four submaps illustrated in FIG. 11.

FIG. 13 is an exemplary diagram of four submaps having different noise levels according to an embodiment of the present invention.

FIG. 14 is a graph showing a free space histogram of the four submaps illustrated in FIG. 13.

FIG. 15 is a flowchart for describing in detail a process of calculating a reflection symmetry score according to an embodiment of the present invention.

FIG. 16 is an exemplary diagram of an image generated in each step of FIG. 15.

FIG. 17 is a function block diagram for global localization of mobile robots according to an embodiment of the present invention.

FIG. 18 is a block diagram illustrating a computing device for performing global localization according to an embodiment of the present invention.

### MODE FOR INVENTION

The present invention proposes a global localization method of mobile robots using a submap partitioned from a global map. Here, the global map may be a “2D occupancy grid map”. In the present specification, a global map is regarded as the same term as a ‘global map image’, and a submap is regarded as a ‘submap image’ or an ‘input submap image’. Also, a 2D occupancy grid map is regarded as a ‘2D occupancy grid map image’.

A global localization method of mobile robots according to the present invention includes a process of extracting a statistic representing distribution features of an occupied region and an unoccupied region in a submap, unlike a method of extracting a feature point of an image. Here, the extracted statistic is defined as a global descriptor.

For example, the present invention partitions a submap into a boundary region (or the occupied region) and a free space region (or the unoccupied region) and generates data of a histogram type (hereinafter referred to as histogram data or a histogram value), representing distribution features of each region, as a global descriptor.

A global descriptor representing distribution features of a boundary region and a global descriptor representing distribution features of a boundary region may be used as “(geometric feature information” about a submap.

Moreover, the global localization method of mobile robots according to the present invention includes a process of calculating a reflection symmetry score representing structural feature information about a submap so as to digitize a “structural feature or symmetrical feature” of a submap. Here, the reflection symmetry score may be used as a weighting factor in calculating a similarity score between a submap and a query submap.

The global localization method of mobile robots according to the present invention may introduce structural information about a submap (i.e., a symmetry score) and may digitize structural feature information about an indoor space, thereby enhancing the matching performance of the submap.

Moreover, the present invention may provide explicit integration of geometric feature information and structural feature information about a submap to secure robustness to noise applied to the submap.

Moreover, the present invention may be applied to all sensors (for example, ultrasonic sensors, 2D/3D LiDAR, 3D depth cameras) for generating a two-dimensional (2D) occupancy grid map.

Moreover, the present invention may be applied to a 2D floor plan map of an indoor building, and thus, it may not be required to previously build a map by using a robot.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components. The present application, it should be understood that the term “connect” denotes a physical connection between elements described in the present specification and moreover includes an electrical connection and a network connection.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

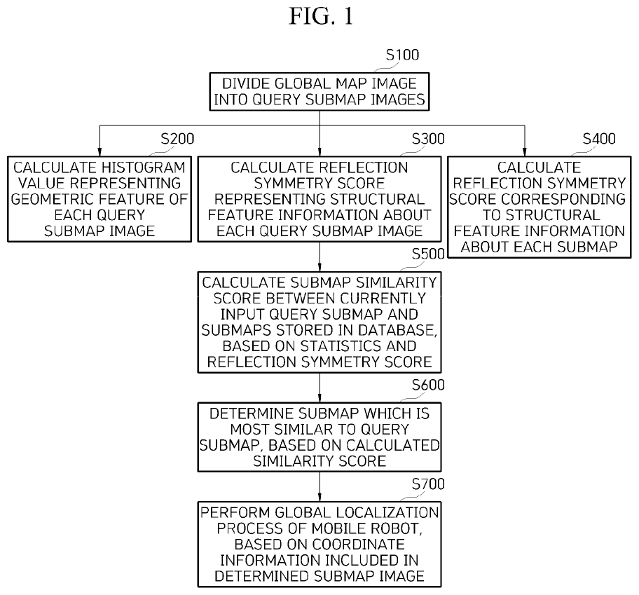

FIG. 1 is a flowchart for describing a method for global localization of mobile robots according to an embodiment of the present invention.

A main element for performing steps S100 to S700 described below may be a computing device which is equipped in a mobile robot (or a moving robot) or is disposed outside a mobile robot. The computing device may be configured to include a processor which performs an operation of processing data and image, a memory which temporarily stores program instructions needed for processing data and an image, temporarily stores intermediate data and resultant data processed by the processor, or provides an execution space of a program or software module executed by the processor, a storage medium which permanently stores the intermediate data and the resultant data processed by the processor or permanently stores the intermediate data and the resultant data in a database form, an input/output interface which receives a user command and outputs the intermediate data and the resultant data in a visual or acoustic information type, and a communication module which supports wired or wireless communication with an external device. Here, the processor may be hardware configured to include at least one of at least one graphics processing unit (GPU), at least one microcontroller unit (MCU), at least one system on chip (SoC), and/or a combination thereof.

Referring to FIG. 1, first, in step S100, a process of partitioning a global map into a plurality of submaps is performed. Here, the global map may be a 2D/3D occupancy grid map generated by using a sensor such as a 2D laser scanner or a 2D LiDAR equipped in a mobile robot.

Steps performed subsequently to the step S100 is performed in parallel or sequentially. In the present specification, it is assumed that the steps S200, S300, and S400 are simultaneously performed in parallel.

In step S200, a process of calculating a first statistic of geometric feature information or distribution features of a boundary region (or an occupied region) in each submap is performed. Here, the first statistic may be a boundary histogram obtained by digitizing (or quantifying) the geometric feature information about the boundary region (or the occupied region), and the boundary histogram may be used as a global descriptor representing the geometric feature information about the boundary region.

In step S300 performed in parallel with step S200, a process of calculating a second statistic of geometric feature information or distribution features of a free space region (or an unoccupied region) in each submap is performed. Here, the second statistic may be a free space histogram obtained by digitizing (or quantifying) the geometric feature information about the free space region (or the unoccupied region), and the free space histogram may be used as a global descriptor representing the geometric feature information about the free space region.

In step S400 performed in parallel with steps S200 and S300, a process of a reflection symmetry score corresponding to structural feature information about each submap is performed.

The statistics (i.e., the boundary histogram, the free space histogram, and the reflection symmetry score) respectively calculated in steps S200, S300, and S400 are calculated offline before performing actual global localization and is stored in a database together with a submap.

Subsequently, in step S500, a process of calculating a similarity score between a currently input query submap and submaps stored in the database on the basis of the first statistic, the second statistic, and the reflection symmetry score is performed.

Subsequently, in step S600, a process of selecting a submap, which is the most similar to the query submap, from among the submaps stored in the database on the basis of the calculated similarity score is performed for comparing with a submap. Here, the above-described calculation processes steps S200 to S400 on the query submap may be performed.

Subsequently, in step S700, a process of performing global localization of a mobile robot on the basis of coordinate information included in the selected submap is performed.

Steps S500 and S600 may be a process of comparing a submap with all submaps Si stored in the database to find a best matched submap and may be integrated into one step.

Hereinafter, each step described above will be described in detail.

### Process S100 of Partitioning Global Map (or 2D Occupancy Grid Map) Into a Plurality of Submaps

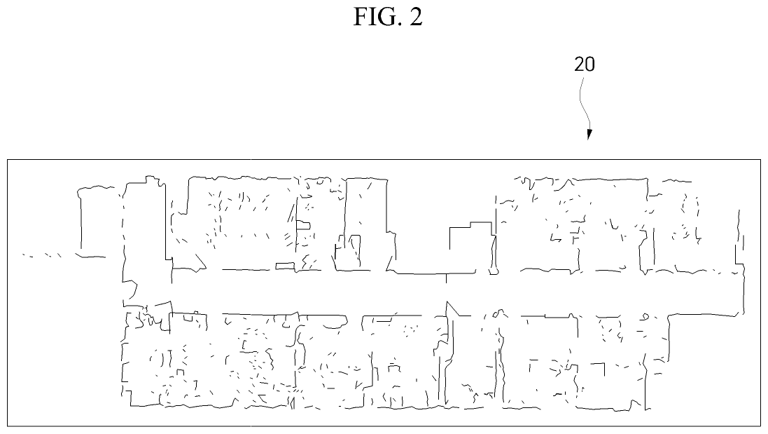

FIG. 2 is a diagram illustrating an example of a 2D occupancy grid map used as a global map according to an embodiment of the present invention.

Referring to FIG. 2, the 2D occupancy grid map 20 used as a global map according to an embodiment of the present invention may be generated based on 2D laser scan data obtained by a 2D laser scanner (or 2D LiDAR) equipped in a mobile robot or a moving robot.

In order to find a position of a robot in the 2D occupancy grid map 20, a latest generated submap should be compared with the 2D occupancy grid map 20. Accordingly, a process of partitioning the 2D occupancy grid map 20 by predetermined units is needed.

The 2D occupancy grid map 20 may be partitioned at a uniform interval, but in this case, a submap including a region where a robot is incapable of being located may be generated, and thus, in order to prevent this, in an embodiment of the present invention, a plurality of submaps are generated by partitioning the 2D occupancy grid map 20 with respect to a junction point of the 2D occupancy grid map 20. Here, the junction point may denote a point, from which a movement path of a robot branches, of a 2D occupancy grid map.

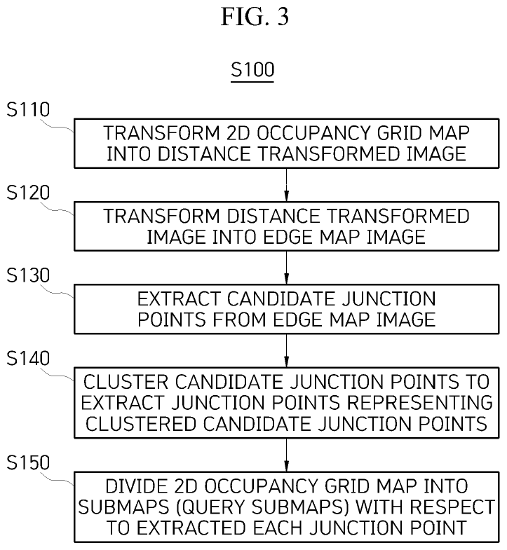

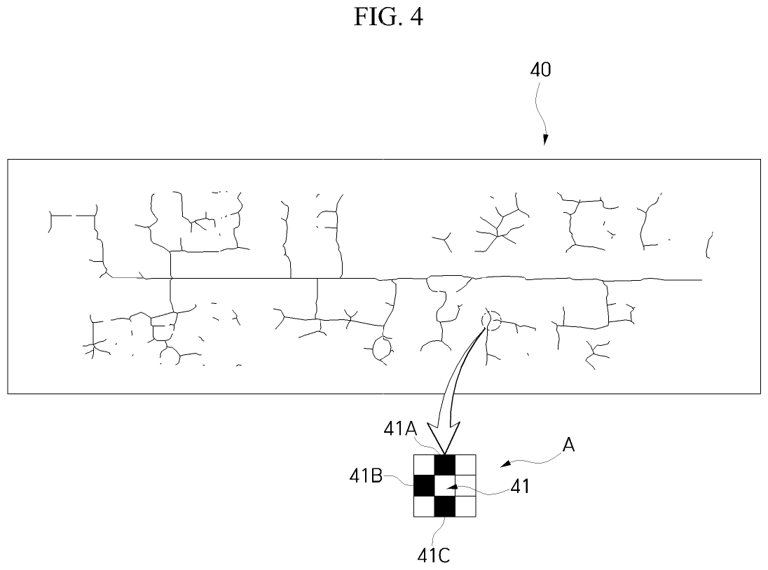

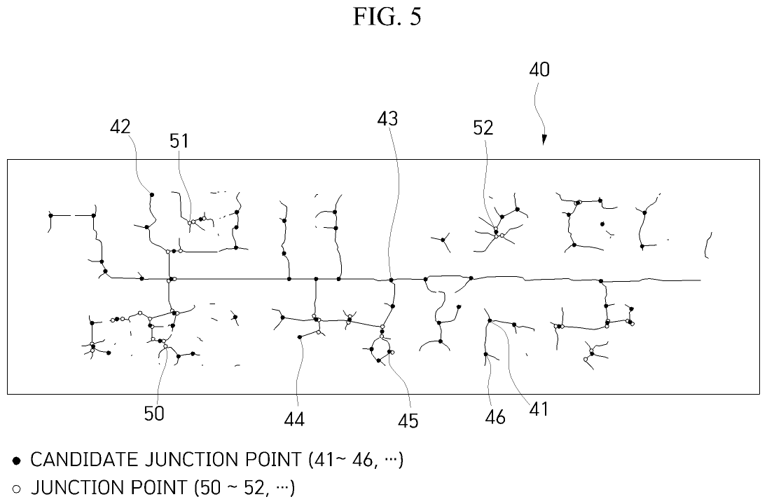

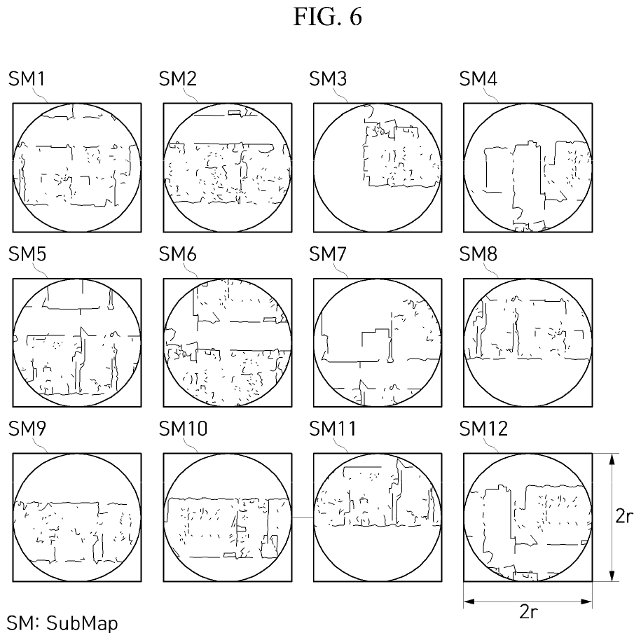

FIG. 3 is a flowchart for describing in detail a process of partitioning a 2D occupancy grid map, used as a global map, a plurality of submaps according to an embodiment of the present invention, FIG. 4 is a diagram illustrating an edge map image which is generated in step S120 of FIG. 3, and FIG. 5 is a diagram illustrating candidate junction points extracted in step S130 of FIG. 3 and junction points extracted in step S140 on the edge map image illustrated in FIG. 4. Also, FIG. 6 is an exemplary diagram of a plurality of submaps partitioned from the 2D occupancy grid map in step S150 of FIG. 3.

Referring to FIG. 3, first, in step S110, in order to detect a free space region of a 2D occupancy grid map 20, the 2D occupancy grid map 20 is transformed into a binary map image consisting of a binary scale, and then, the binary map image is transformed into a distance transformed image (or a distance transformed map image), based on a distance transform technique which is one of image processing techniques.

Subsequently, in step S120, the distance transformed image includes a free space region which is not important, and thus, in order to extract only a main navigation path, the distance transformed image is transformed into an edge map image (40 of FIG. 4) having a 1-pixel width, based on a morphological operation technique (for example, an erosion morphological operator) and an image thinning technique.

Subsequently, in step S130, candidate junction points (41, 42, 43, 44, 45, 46, . . . of FIG. 5) are extracted by performing a junction test in all nonzero pixels of the edge map image (40 of FIG. 4). Here, the junction test extracts, for example, a 3×3 image patch (A of FIG. 4) where all pixels configuring an edge (boundary) are provided as a center pixel 41 in the edge map image (40 of FIG. 4). Subsequently, when a pixel value of at least three peripheral pixels among peripheral pixels 41A, 41B, and 41C surrounding the center pixel 41 in the 3×3 image patch (A of FIG. 4) differs from a pixel value of the center pixel 41, the center pixel 41 is extracted as a candidate junction point. In FIG. 4, an example of the 3×3 image patch A where the center pixel 41 is a white gray scale and the peripheral pixels 41A, 41B, and 41C consist of a black gray scale is illustrated, and in this case, the center pixel 41 may be defined as a candidate junction point which branches in three directions.

Subsequently, in step S140, junction points 50, 51, 52, . . . of FIG. 5 representing clustered candidate junction points 41 to 46 of FIG. 5 are extracted by clustering the candidate junction points a density-based spatial clustering technique.

Subsequently, in step S150, the 2D occupancy grid map 20 may be expressed as a sum of a plurality of submap images having a certain radius r with respect to each junction point, and in this case, the 2D occupancy grid map 20 is partitioned into a plurality of submaps where each junction point is a center point. In FIG. 6, an example where the 2D occupancy grid map 20 of FIG. 2 is partitioned into twelve submap images SM1 to SM12 in steps S110 to S150 is illustrated.

### Calculation S200 of Statistic of Geometric Feature Information About Boundary Region

Geometric feature information about a boundary region denotes distribution features of pixels configuring a boundary region (i.e., an occupied region) in a submap, and statistic denotes data or a value, where the distribution features of the pixels configuring the occupied region are transformed into a histogram.

The boundary region denotes an overall outer line capable of being shown in a submap. This is a significant feature which enables differentiation of a submap. In an embodiment of the present invention, the follow processes are performed for calculating a statistic for digitizing a geometric feature or a distribution feature of a boundary region capable of being shown in a submap.

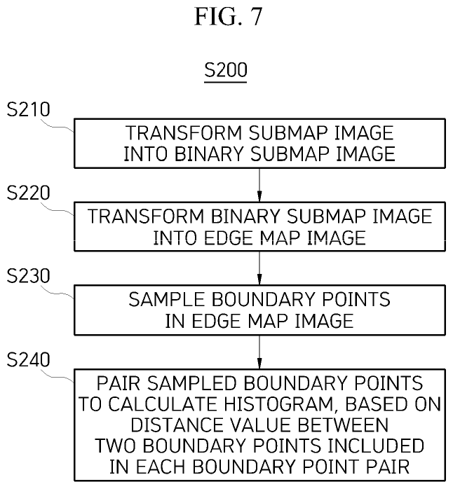

FIG. 7 is a flowchart for describing in detail a statistic calculation process on geometric feature information about a boundary region according to an embodiment of the present invention.

Referring to FIG. 7, first, in step S210, a process of transforming a submap image (or a query submap image) into a binary submap image on the basis of various image processing techniques is performed. Each pixel value of a submap represents the degree of occupancy. In order to remove internal ambiguous pixels of a submap and consider only clearly occupied pixels, a submap image is transformed into a binary submap image Sᵢ^{B} on the basis of an inverse-binary thresholding algorithm. Here, an upper subscript B in Sᵢ^{B} denotes an abbreviation of binary, and a lower subscript i denotes an i^{th} binary submap image.

Subsequently, in step S220, a process of transforming the binary submap image Sᵢ^{B} into an edge map image Sᵢ^{E} on the basis of various image processing techniques are performed. Here, an upper subscript E in Sᵢ^{E} denotes an abbreviation of edge. A structure such as a wall may be expressed as a clustered occupied region due to sensor noise or a mapping error in a mapping process. In order to transfer the binary submap image Sᵢ^{B} into the edge map image Sᵢ^{E}, an image thinning technique may be used. For example, the binary submap image Sᵢ^{B} may be transformed into the edge map image Sᵢ^{E} having a 1-pixel width based on the image thinning technique.

Subsequently, in step S230, a process of sampling boundary points (or edge points) configuring the boundary region in the edge map image Sᵢ^{E} is performed. The boundary points denote a set of nonzero pixels in the edge map image Sᵢ^{E}. In an embodiment of the present invention, the boundary points are sampled based on a uniform sampling technique. The number of boundary points may be reduced by the uniform sampling technique, and thus, the number of calculations may decrease.

Subsequently, in step S240, a process of generating a plurality of boundary point pairs where sampled boundary points are paired and calculating a boundary histogram value (1D histogram Hᵢ^{b}) where a distance value between two boundary points included each boundary point pair is a bin is performed. Here, the bin denotes one interval of a historgram.

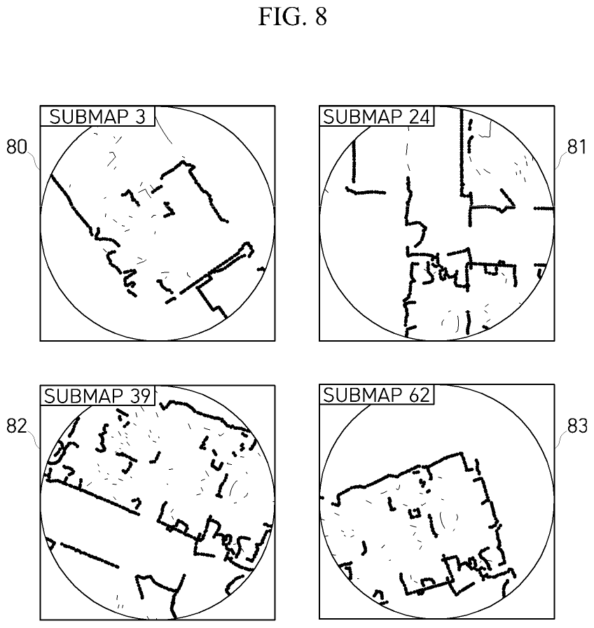

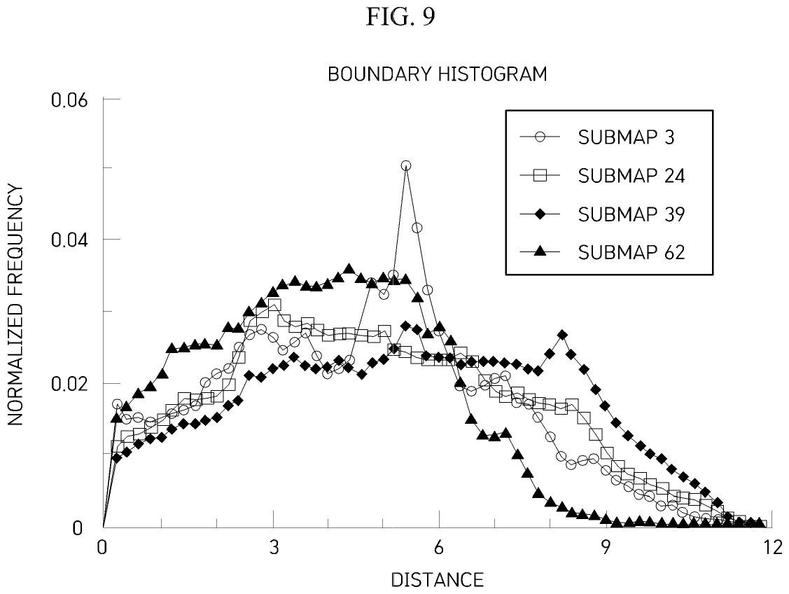

FIG. 8 is an exemplary diagram of four submaps where a boundary region is displayed as boundary points, according to an embodiment of the present invention, and FIG. 9 is a graph showing a boundary histogram of the four submaps illustrated in FIG. 8.

Referring to FIGS. 8 and 9, a histogram of a submap 3 referred to by reference numeral 80 and histograms of other submaps 81 to 83 are clearly differentiated from one another. However, a submap 24 referred to by reference numeral 81 and a submap 39 referred to by reference numeral 82 have different boundary shapes but have similar changes.

This denotes that there is a limitation in differentiating all submaps by using one histogram factor representing distribution features or geometric features of boundary points (boundary region). That is, this denotes that geometric feature information about a free space region described below as well as geometric feature information about a boundary region should be considered together, in differentiating all submaps.

### Calculation S300 of Statistic of Geometric Feature Information About Free Space Region

A free space region of a submap denotes a region or a path, which enables a mobile robot to move actually. This provides useful geometric feature information which enables an internal structure of a submap to be known. The geometric feature information may be merged with the geometric feature information about the boundary region described above, thereby increasing submap matching performance. An embodiment of the present invention performs the following processes to generate a statistic (i.e., a histogram) obtained by digitizing geometric feature information or distribution feature of the free space region.

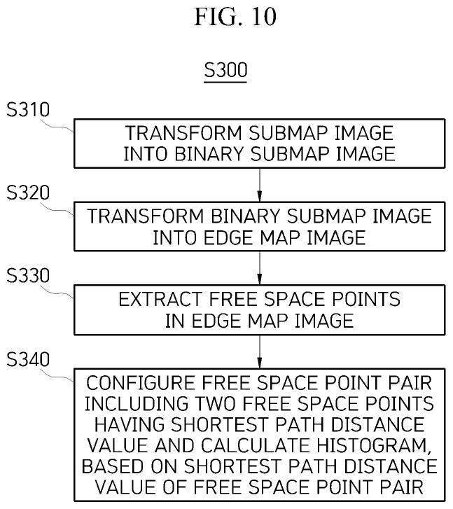

FIG. 10 is a flowchart for describing in detail a statistic calculation process on geometric feature information about a free space region according to an embodiment of the present invention.

Referring to FIG. 10, first, in step S310, a process of transforming a submap image (or a query submap image) into a binary submap image on the basis of various image processing techniques is performed. Step S310 includes steps S110 and S120 of FIG. 1.

Subsequently, in step S320, a process of transforming the binary submap image into an edge map image on the basis of various image processing techniques is performed. Step S320 is almost identical to step S130 of FIG. 1.

Subsequently, in step S330, a process of extracting (sampling) free space points Vᵢ^{F} configuring a free space region in the edge map image is performed. Step S330 is almost similar to step S130 of FIG. 1. However, the free space points denote a set of zero pixels instead of nonzero pixels in the edge map image, and thus, there is a difference between step S330 and step S130 of FIG. 1.

Subsequently, in step S340, a process of calculating a shortest path distance value between the free space points among the extracted (sampled) free space points is performed. A visibility graph may be configured with free space points, and thus, a shortest distance path connected between an arbitrary free space point m and another arbitrary free space point n may be obtained. The visibility graph may be expressed as adjacency matrix A=[aₘₙ], and each element amn of an adjacency matrix is an Euclidean distance between free space points. When an occupied pixel is a rectilinear path from the free space point m to the free space point n, aₘₙ has an infinite value. A Dijkstra algorithm may be used for calculating a shortest path distance value.

Subsequently, in step S350, a process of configuring a free space point pair including two free space points having the shortest path distance value and calculating a free space histogram value (1D histogram [symbol] ) where the shortest path distance value of the free space point pair is a bin is performed. Here, an upper subscript f in [symbol] denotes an abbreviation of free space.

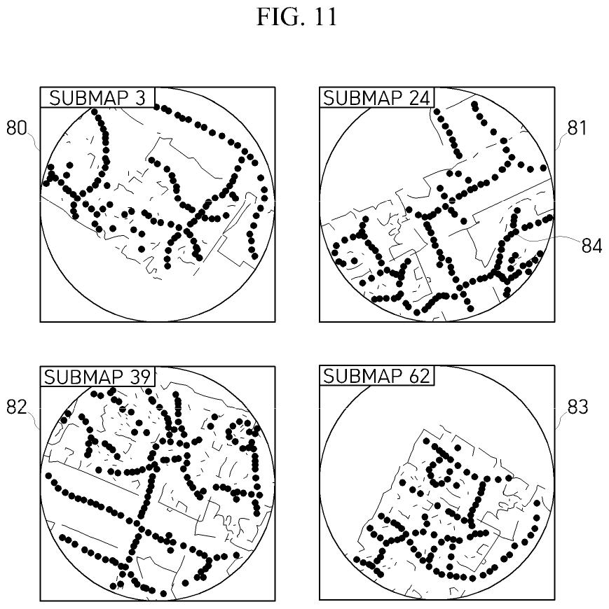

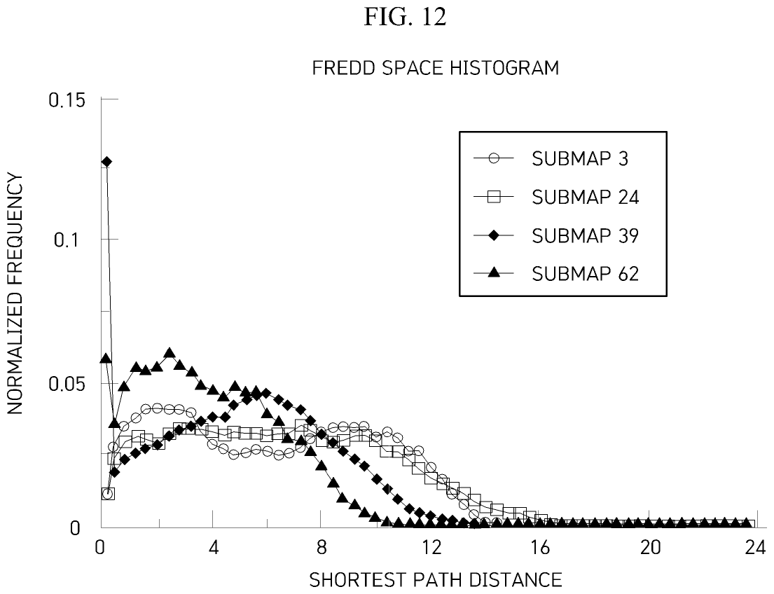

FIG. 11 is an exemplary diagram of four submaps where a free space region is displayed as free space points 84, according to an embodiment of the present invention, and FIG. 12 is a graph showing a free space histogram of the four submaps illustrated in FIG. 11.

Submaps 80 to 83 illustrated in FIG. 11 are the same as submaps 80 to 83 illustrated in FIG. 8. Also, the submaps 80 to 83 illustrated in FIG. 11 are obtained by rotating the submaps 80 to 83 illustrated in FIG. 8 by a certain angle.

A submap 24 referred to by reference numeral 81 and a submap 39 referred to by reference numeral 82 are difficult to be differentiated from each other in the boundary histogram illustrated in FIG. 9, but a slightly clear difference may be checked in a free space histogram as illustrated in FIG. 12.

However, the free space histogram is similar to a histogram change tendency of each of the submap 3 and the submap 24 unlike a boundary histogram. This denotes that the boundary histogram and the free space histogram have a complementary feature and performance of differentiating a place through a combination of two histograms may increase.

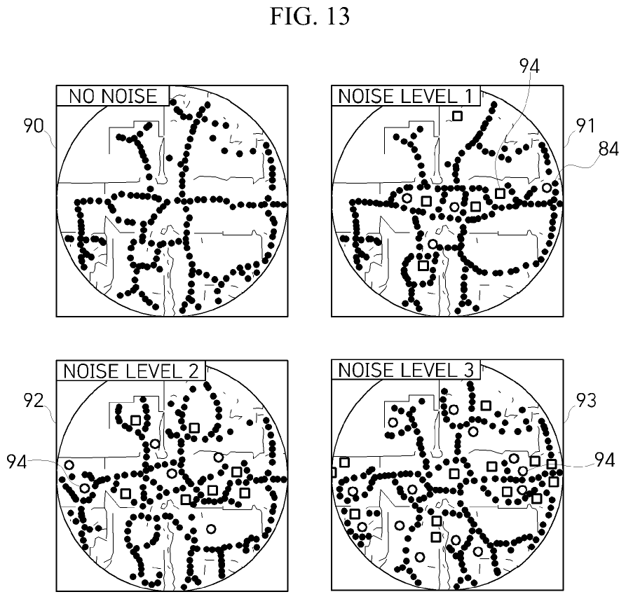

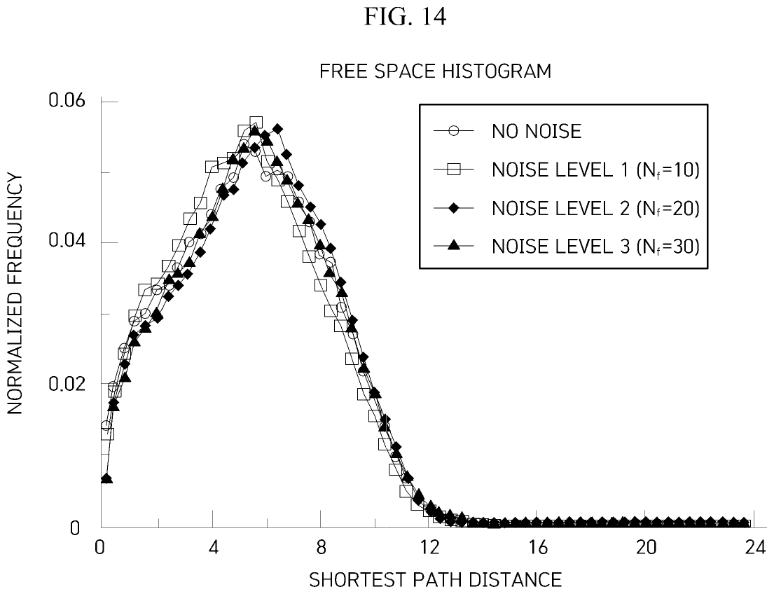

FIG. 13 is an exemplary diagram of four submaps having different noise levels according to an embodiment of the present invention, and FIG. 14 is a graph showing a free space histogram of the four submaps illustrated in FIG. 13.

Referring to FIGS. 13 and 14, in order to check robustness of a free space histogram to noise, Nr number of virtual obstacles 94 which are not in a mapping process are randomly arranged in submaps 91 to 93. A noise level of a submap is determined based on the number of virtual obstacles. Addition of the virtual obstacles 94 changes a histogram representing distribution features of free space points 84. However, this does not greatly affect a shortest path distance. Accordingly, the degree of change of a histogram is slight.

### Calculation S400 of Reflection Symmetry Score

The boundary histogram and the free space histogram described above may be data obtained by digitizing (quantifying) a geometric shape of a submap, and a symmetry score may be data or a value obtained by digitizing (quantifying) a whole structural shape or symmetry of a submap.

A symmetry type includes rotation, reflection, transform, and glide reflection. Reflection symmetry is a general symmetry type which may be shown in an indoor structure. In an embodiment of the present invention, a reflection symmetry score is calculated from a submap image through the following processes, and the calculate reflection symmetry score is used as a weight in calculating (S500 of FIG. 1) a submap similarity score.

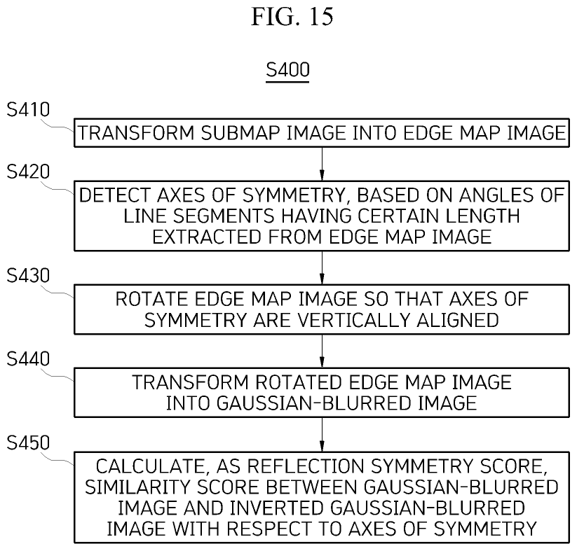

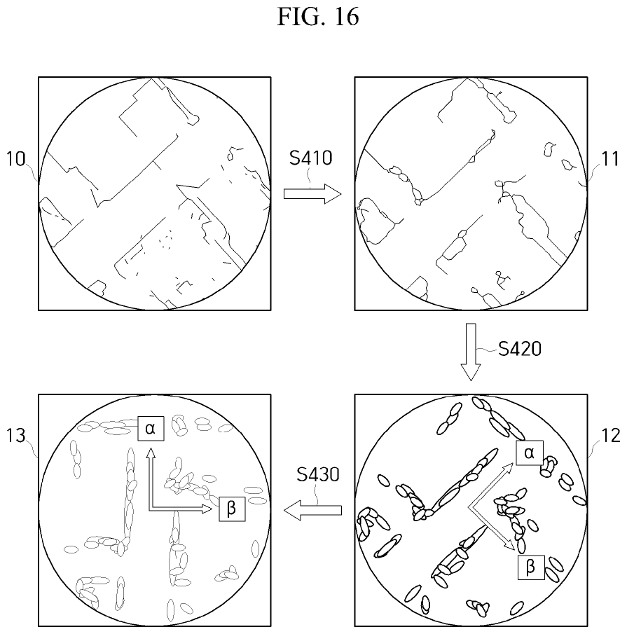

FIG. 15 is a flowchart for describing in detail a process of calculating a reflection symmetry score according to an embodiment of the present invention, and FIG. 16 is an exemplary diagram of an image generated in each step of FIG. 15.

Referring to FIGS. 15 and 16, first, in step S410, a process of transforming a submap image 10 into an edge map image on the basis of various image processing techniques is performed. Step S410 may include, for example, a process of transforming the submap image 10 into a binary submap image like a performance process of step S210 of FIG. 7 and then transforming a binary submap image into Sᵢ^{B} an edge map image Sᵢ^{E} 11 like step S220 of FIG. 7.

Subsequently, in step S420, a process of detecting two axes of symmetry α and β on the basis of angles of line segments having a certain length extracted from the edge map image Sᵢ^{E} 11. In order to extract the line segments having a certain length or more, for example, a probabilistic Hough transform algorithm may be used. Because an indoor structure of a building is an approximately rectangular shape, the two axes of symmetry α and β may be detected by voting angles of the extracted line segments on the basis of a vote algorithm.

Subsequently, in step S430, a process of transforming an edge map image Sᵢ^{E} where the two axes of symmetry α and β have been rotated to be vertically aligned, into a Gaussian-blurred image Sᵢ^{Gα} 13 and then calculating, as a reflection symmetry score, average intensity Sᵢ^{α} of pixels [symbol] (u, v) of a flipped Gaussian-blurred image [symbol] corresponding to a position of all zero pixels (u, v) in the Gaussian-blurred image Sᵢ^{Gα} 13. That is, the calculation of the reflection symmetry score may be a process of calculating a similarity score between the Gaussian-blurred image and the flipped Gaussian-blurred image flipped with respect to the axes of symmetry α and β.

The reflection symmetry score Sᵢ^{α} corresponding to the axis of symmetry α may be expressed as the following Equation 1.

$${S}_{i}^{α} = \frac{{\sum }_{( u , v ) ϵ {N}_{nz}^{α}} {S}_{i}^{\hat{{G}_{α}}} ( u , v )}{\vert {N}_{nz}^{α} \vert} \qquad [ Equation 1 ]$$

The flipped Gaussian-blurred image [symbol] may be, for example, an image obtained by flipping the Gaussian-blurred image Sᵢ^{Gα} 13 with respect to the axes of symmetry. In order to transform the edge map image 11 into the Gaussian-blurred image, various image blurred techniques used in the field of image processing may be used. The rotated edge map image Sᵢ^{E} 11 may be an image which is obtained by rotating the edge map image Sᵢ^{E} 11 so that one of the two axes of symmetry α and β is ß SI vertically aligned. Also, a reflection symmetry score Sᵢ^{β} corresponding to the axis of symmetry β may be calculated by a method described above.

### Calculation S500 of Submap Similarity

Three statistics (i.e., a boundary histogram, a free space histogram, and a reflection symmetry score) calculated above are calculated offline before performing actual global localization and is stored in a database together with input submaps Sᵢ. Subsequently, when a query submap S_{q} is generated in a driving process of a robot, a process of calculating a matching score on the basis of the following Equation 2 and calculating inversion of the calculated matching score as a similarity score ρ is performed.

When the calculation of the similarity score ρ is completed, a submap matching the query submap S_{q} is selected from among the submaps Sᵢ stored in the database, based thereon in step S700.

$$s = m ( {S}_{q} , {S}_{i} ) = Ω ( {s}_{q}^{α} , {s}_{q}^{β} , {s}_{i}^{α} , {s}_{i}^{β} ) \times [ {w}_{b} \cdot d ( , ) + {w}_{f} \cdot d ( , ) ] \qquad [ Equation 2 ]$$

Here, S and m (S_{q}, Sᵢ) is a similarity score between the query submap S_{q} and the input submap Sᵢ stored in the database, Sᵢ^{α} and Sᵢ^{β} respectively represent reflection symmetry scores based on the axes of symmetry α and β of the submap Sᵢ, and S_{q}^{α} and S_{q}^{β} respectively represent reflection symmetry scores based on the axes of symmetry α and β of the query submap S_{q}. That is, Sᵢ^{α} is a score representing the degree of similarity between a left submap and a right submap differentiated from each other with respect to the axis of symmetry α, and Sᵢ^{β} is a score representing the degree of similarity between a left submap and a right submap differentiated from each other with respect to the axis of symmetry β. Similarly, S_{q}^{α} is a score representing the degree of similarity between a left query submap and a right query submap differentiated from each other with respect to the axis of symmetry α, and S_{q}^{β} is a score representing the degree of similarity between a left query submap and a right query submap differentiated from each other with respect to the axis of symmetry β. Ω ( ) may be a function of calculating a similarity of a structural feature between the query submap S_{q} and the submap Sᵢ, and Ω (S_{q}^{α}, S_{q}^{β}, Sᵢ^{α}, Sᵢ^{β}) may be represented as Ø (S_{q}^{α}, Sᵢ^{α})·Ø (S_{q}^{β}, Sᵢ^{β}). Here, Ø (S_{q}^{α}, Sᵢ^{α}) is an equation of calculating a difference value between the reflection symmetry score S_{q}^{α} of the query submap S_{q} based on the axis of symmetry α and the reflection symmetry score Sᵢ^{α} of the submap Sᵢ based on the axis of symmetry α, and Ø (S_{q}^{β}, Sᵢ^{β}) is an equation of calculating a difference value between the reflection symmetry score of the query submap S_{q} based on the axis of symmetry β and the reflection symmetry score of the submap Sᵢ based on the axis of symmetry β. Accordingly, a similarity of a structural feature between the query submap S_{q} and the submap Sᵢ may be calculated by multiplying the difference value Ø (S_{q}^{α}, Sᵢ^{α}) by the difference value Ø (S_{q}^{β}, Sᵢ^{β}).

Hᵢ^{b} and [symbol] respectively represent a boundary histogram and a free space histogram (value) of the input submap Sᵢ, and H_{q}and H_{q}^{ƒ} respectively represent a boundary histogram (value) and a free space histogram (value) of the query submap S_{q}. Also, w_{b} represents a matching weight between a boundary histogram (value) of the query submap S_{q} and a boundary histogram (value) of the submap Sᵢ, and w_{f} represents a matching weight between a free space histogram (value) of the query submap S_{q} and a free space histogram (value) of the submap Sᵢ. Also, Ω ( ) is a function of calculating a similarity of structural feature information between the query submap and the input submap stored in the database.

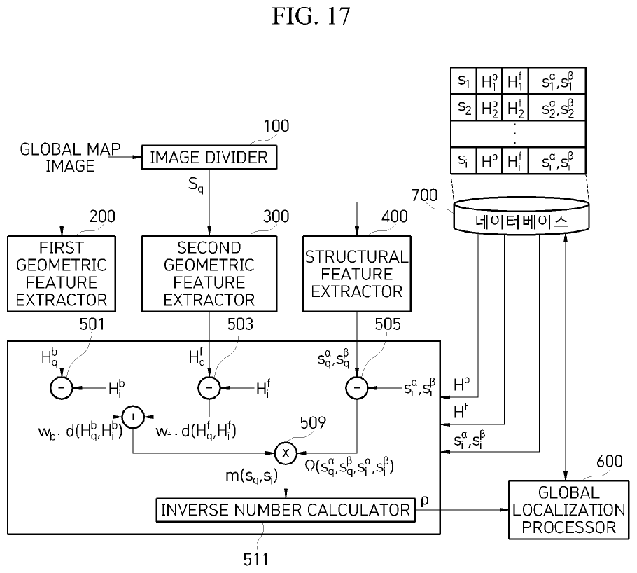

FIG. 17 is a function block diagram for global localization of mobile robots according to an embodiment of the present invention.

Referring to FIG. 17, an apparatus for global localization according to an embodiment of the present invention includes an image divider 100, a first geometric feature extractor 200, a second geometric feature extractor 300, a structural feature extractor 400, a submap similarity score calculator 500, a global localization processor 600, and a database 700.

The elements 100 to 700 may be classified by function units so as to help understand description, and moreover, do not intend to limit the present invention may be variously modified. For example, some of the elements may be integrated into one element, or one of the elements may be classified into a plurality of elements by detailed function units. For example, the first geometric feature extractor 200, the second geometric feature extractor 300, and the structural feature extractor 400 may be integrated into one element and referred to as a ‘feature extractor’. Also, each element may be implemented as a hardware module or a software module, or may be implemented as a combination thereof. Here, the hardware module may be implemented as a semiconductor chip including a processor implemented with at least one CPU, GUP, and/or MCU, and the software module may be implemented with a program and/or an algorithm executed by a processor.

To describe each element in detail, first, the image divider 100 divides a global map image into a plurality of query submap images. To this end, for example, the image divider 100 may process processes performed based on step S100 of FIG. 1 or 3. Here, the global image may be a 2D or 3D occupancy grid map image.

The first geometric feature extractor 200 extracts a first geometric feature of each query submap image S_{q}. To this end, for example, the first geometric feature extractor 200 may process processes performed based on step S200 of FIG. 1 or 7. Here, the first geometric feature may be a boundary histogram (value) obtained by digitizing (qualifying) distribution features of a boundary region included in each query submap image S_{q}. The boundary region may be a region where a robot may not move.

The second geometric feature extractor 300 extracts a second geometric feature of each query submap image S_{q}. To this end, for example, the second geometric feature extractor 300 may process processes performed based on step S300 of FIG. 1 or 10. Here, the second geometric feature may be a free space histogram (value) obtained by digitizing (qualifying) distribution features of a free space region included in each query submap image S_{q}. The free space region may be a region where a robot may move.

The structural feature extractor 400 extracts a structural feature of each query submap image S_{q}. To this end, for example, the structural feature extractor 400 may process processes performed based on step S400 of FIGS. 1 and 15. Here, the structural feature may be a reflection symmetry score obtained by digitizing (qualifying) a whole structural shape of each query submap image S_{q}.

In order to calculate the reflection symmetry score, the structural feature extractor 400 may include, for example, three subtractors 501 to 503, an adder 507, a multiplier 509, and an inverse number calculator 511.

A first subtractor 501 calculates a difference value W_{b}·d(H_{q}^{b}, Hᵢ^{b}) between a boundary histogram value H_{q}^{b} of the query submap S_{q} extracted (calculated) by the first geometric feature extractor 200 and a boundary histogram value Hᵢ^{b} of an input submap Sᵢ previously stored in the database 700. In this case, a matching weight w_{b} may be applied to a difference value d(H_{q}^{b}, Hᵢ^{b})

A second subtractor 503 calculates a difference value w_{ƒ}·d(H_{q}^{ƒ}, Hᵢ^{ƒ}) between a free space histogram value H_{q}^{ƒ} of the query submap S_{q} extracted (calculated) by the second geometric feature extractor 300 and a free space histogram value [symbol] of the input submap Sᵢ previously stored in the database 700. In this case, the matching weight w_{b} may be applied to a difference value d(H_{q}^{ƒ}, Hᵢ^{ƒ}).

A third subtractor 505 calculates a difference value Ω(S_{q}^{α}, S_{q} ^{β}, Sᵢ^{α}, Sᵢ^{β}) between a reflection symmetry score based on axes of symmetry α and β of the query submap S_{q} extracted (calculated) by the structural feature extractor 400 and a reflection symmetry score based on axes of symmetry α and β of the input submap Sᵢ previously stored in the database 700.

The subtractor 507 summates the difference value W_{b}·d(H_{q}^{b}, Hᵢ^{b}) from the first subtractor 501 and the difference value w_{ƒ}·d(H_{q}^{ƒ}, Hᵢ^{ƒ})from the second subtractor 503.

The multiplier 507 performs a multiplication operation on an output of the adder 507 and an output of the third subtractor 505 to output an obtained matching score m(S_{q}, Sᵢ).

The inverse number calculator 511 calculates an inverse number of the matching score m(S_{q}, Sᵢ) as a submap similarity score ρ between the query submap S_{q} and the input submap Sᵢ.

The global localization processor 600 determines an input submap Sᵢ which is the most similar to the query submap S_{q}, based on the submap similarity score ρ, and performs a global localization process of a mobile robot on the basis of coordinate information included in the determined input submap Sᵢ. The global localization processor 600 may process processes based on steps S600 and S700 of FIG. 1.

A boundary region Hᵢ^{b}, a free space histogram [symbol] , and a reflection symmetry score Sᵢ^{α} and Sᵢ^{β} , which are previously calculated for each submap Sᵢ, are stored in the database 700. The database 700 may be stored in a non-volatile storage medium.

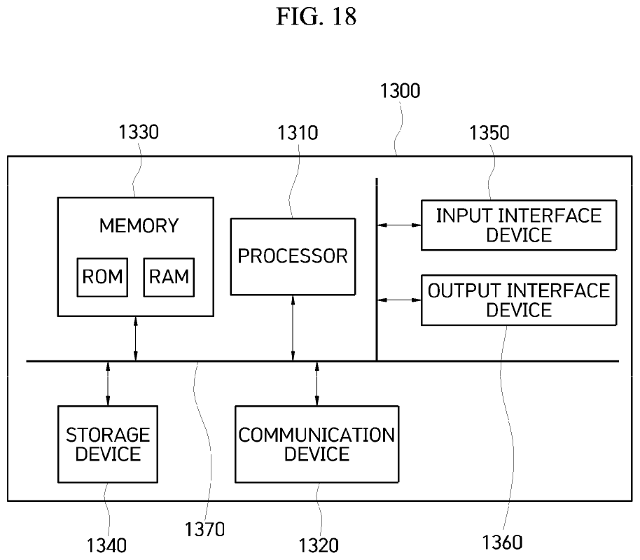

FIG. 18 is a block diagram illustrating a computing device for performing global localization according to an embodiment of the present invention.

Referring to FIG. 18, a computing device 130 may be equipped in an external device which is equipped in a robot or communicates with the robot. The computing device 1300 may include at least one of a processor 1310, a memory 1330, an input interface device 1350, an output interface device 1360, and a storage device 1340, which communicate with one another through a bus 1370. Also, a portable computer 1300 may include a communication device 1320 connected to a network.

The processor 1310 may include at least one CPU, at least one GPU, and at least one MPU and may be a semiconductor device which executes an instruction stored in the memory 1330 or the storage device 1340. Also, the processor 1310 may control the elements and/or the processes illustrated in FIGS. 1 to 17, or may process or calculate. Particularly, the processor 1310 may include high-performance CPU and GPU which have performance sufficient to process an image.

The memory 1330 and the storage device 1340 may include various types of volatile or non-volatile storage mediums. For example, the memory may include read only memory (ROM) and random access memory (RAM). For example, the storage device 1340 may be a hard disk. The database 700 illustrated in FIG. 17 may be stored in the storage device 1340.

The communication device 1320 may be a communication module which supports wired or/and wireless communication. Data and images processed by the processor 1310 may be transmitted to an external device by the communication device 1320.

The input interface device 1350 may be implemented with a button, a mouse, a keyboard, and a display unit having a touch function.

The output interface device 1360 may output intermediate data and resultant data, processed by the processor 1310, in a visual or acoustic information type. The resultant data may be position information about a robot finally obtained by performing global localization.

Hereinabove, the embodiments of the present invention have been described in detail, but the scope of the present invention is not limited thereto and several modifications and improvements accomplished by those skilled in the art by using a fundamental concept of the present invention defined in the following claims are within the scope of the present invention.

### Industrial Applicability

The present invention may be applied to all sensors (for example, ultrasonic sensors, 2D/3D LiDAR, 3D depth cameras) for generating a 2D occupancy grid map and may be applied to a 2D floor plan map of an indoor building.

1. A method for global localization of a mobile robot, performed by a processor of a computing device equipped in the mobile robot, the method comprising:
dividing a global map image into a plurality of query submap images;
calculating a histogram value representing a geometric feature of each query submap image;
calculating a reflection symmetry score representing structural feature information about each query submap image;
calculating a submap similarity score between each query submap image and submap images stored in a database, based on the histogram value and the reflection symmetry score; and
determining a submap image which is the most similar to the query submap image, based on the submap similarity score, and performing the global localization of the mobile robot, based on coordinate information included in the determined submap image.

2. The method of claim 1, wherein the dividing of the global map image into the plurality of query submap images comprises:
generating the global map image by using a sensor equipped in the mobile robot;
extracting a junction point, defining a point from which a movement path of the mobile robot branches, from the global map image; and
dividing the global map image into the plurality of query submap images having a certain radius with respect to the junction point.

3. The method of claim 2, wherein the extracting of the junction point comprises:
transforming the global map image into an edge map image, based on an image processing technique; and
when an n×n image patch including a center pixel of the edge map image and peripheral pixels surrounding the center pixel is assumed, extracting the center pixel as the junction point when a pixel value of the center pixel differs from pixel values of at least three peripheral pixels.

4. The method of claim 1, wherein the calculating of the histogram value representing the geometric feature of each query submap image comprises:
calculating a boundary histogram value representing a geometric feature of a boundary region, where the mobile robot is incapable of moving, in each query submap image; and
calculating a free space histogram value representing a geometric feature of a free space region, where the mobile robot is capable of moving, in each query submap image.

5. The method of claim 4, wherein the calculating of the boundary histogram value comprises:
transforming each query submap image into an edge map image, based on an image processing technique;
sampling boundary points configuring the boundary region in the edge map image;
pairing the sampled boundary points to generate a plurality of boundary point pairs; and
calculating the boundary histogram value, based on a distance value between two boundary points included in each boundary point pair.

6. The method of claim 4, wherein the calculating of the free space histogram value comprises:
transforming each query submap image into an edge map image, based on an image processing technique;
extracting free space points configuring the free space region in the edge map image;
pairing two free space points having a shortest path distance value among the extracted free space points to generate a plurality of free space point pairs; and
calculating the free space histogram value, based on the shortest path distance value of each free space point pair.

7. The method of claim 1, wherein the calculating of the reflection symmetry score comprises:
transforming each query submap image into an edge map image, based on an image processing technique;
detecting axes of reflection symmetry in the edge map image, based on angles of line segments having a certain length;
transforming the edge map image into a blurred image, based on an image blurred technique; and
calculating, as the reflection symmetry score, a similarity score between the blurred image and a flipped blurred image flipped with respect to the detected axes of reflection symmetry.

8. The method of claim 7, further comprising rotating the edge map image so that the detected axes of reflection symmetry are vertically aligned, between the detecting of the axis of reflection symmetry and the transforming of the edge map image into the blurred image.

9. The method of claim 1, wherein the calculating of the submap similarity score comprises:
calculating a first difference value between the histogram value of each query submap image and histogram values representing the geometric features of the submap images stored in the database;
calculating a second difference value between the reflection symmetry score of each query submap image and reflection symmetry scores representing structural features of the submap images stored in the database; and
calculating the submap similarity score, based on the first and second difference values.

10. The method of claim 9, wherein the calculating of the first difference value comprises:
calculating a difference value between a boundary histogram value, representing the geometric feature of a boundary region where the mobile robot is incapable of moving in each query submap image, and boundary histogram values representing the geometric feature of a boundary region where the mobile robot is incapable of moving in the submap images; and
calculating a difference value between a free space histogram value, representing the geometric feature of a free space region where the mobile robot is capable of moving in each query submap image, and free space histogram values representing the geometric feature of a free space region where the mobile robot is capable of moving.

11. A computing device for global localization of a mobile robot, the computing device comprising:
an image divider configured to divide an occupancy grid map image into a plurality of query submap images;
a feature extractor configured to calculate a histogram value representing a geometric feature of each query submap image and calculate a reflection symmetry score representing a symmetry feature of each query submap image;
a submap similarity score calculator configured to calculate a submap similarity score between each query submap image and submap images stored in a database, based on the histogram value and the reflection symmetry score; and
a global localization processor configured to determine a submap image which is the most similar to the query submap image, based on the submap similarity score, and perform the global localization of the mobile robot, based on coordinate information included in the determined submap image.

12. The computing device of claim 11, wherein the image divider divides the occupancy grid map image into a plurality of query submap images with respect to a junction point from which a movement path of the mobile robot branches, in the occupancy grid map image.

13. The computing device of claim 11, wherein the feature extractor comprises:
a first geometric feature extractor configured to calculate a boundary histogram value obtained by quantifying distribution features of a boundary region where the mobile robot is incapable of moving, in each query submap image;
a second geometric feature extractor configured to calculate a free space histogram value obtained by quantifying distribution features of a free space region where the mobile robot is capable of moving, in each query submap image; and
a structural feature extractor configured to calculate a reflection symmetry score obtained by quantifying symmetricity of each query submap image.

14. The computing device of claim 11, wherein the submap similarity score calculator comprises:
a first subtractor configured to calculate a difference value between a boundary histogram value obtained by quantifying geometric features of a boundary region in each query submap image and a boundary histogram value obtained by quantifying geometric features of a boundary region in a submap image stored in the database;
a second subtractor configured to calculate a difference value between a free space histogram value obtained by quantifying geometric features of a free space region in each query submap image and a boundary histogram value obtained by quantifying geometric features of a free space region of the submap image stored in the database; and
a third subtractor configured to calculate a difference value between the reflection symmetry score obtained by quantifying symmetricity of each query submap image and a reflection symmetry score obtained by quantifying symmetricity of the submap image stored in the database.

15. The computing device of claim 14, wherein the submap similarity score calculator performs an arithmetic operation on the difference values calculated by the first to third subtractors to calculate a similarity score between each query submap image and the submap images.

16. The computing device of claim 14, wherein the submap similarity score calculator further comprises an adder configured to summate the difference value calculated by the first subtractor and the difference value calculated by the second subtractor, and
the submap similarity score calculator performs an arithmetic operation on the difference value calculated by the third subtractor as a weight and a value summated by the adder to calculate a similarity score between each query submap image and the submap images.

17. A method for global localization performed by a processor of a computing device equipped in a mobile robot, the method comprising:
calculating a boundary histogram value obtained by quantifying distribution features of a boundary region where the mobile robot is incapable of moving, in each query submap image divided from a global map image;
calculating a free space histogram value obtained by quantifying distribution features of a free space region where the mobile robot is capable of moving, in each query submap image;
calculating a reflection symmetry score obtained by quantifying symmetricity of each query submap image with respect to an axis of symmetry extracted from each query submap image;
comparing the boundary histogram value, the free space histogram value, and the reflection symmetry score of each query submap image with a boundary histogram value, a free space histogram value, and a reflection symmetry score of submap images input from a database to select a submap image, which is the most similar to each query submap image, from among submap images stored in the database; and
performing the global localization of the mobile robot, based on coordinate information included in the selected submap image.

18. The method of claim 17, wherein the global map image is a 2D or 3D occupancy grid map image.
